(19) United States
(12) Patent Application Publication
(10) Pub. No.: US 2007/0143368 A1
(43) Pub. Date: Jun. 21, 2007

(54) Conflict resolution in highly available network element

(76) Inventors: Soren K. Lundsgaard, Iverness, IL (US); Alex Rozenstrauch, Buffalo Grove, IL (US)

Correspondence Address: MOTOROLA, INC., 1303 EAST ALGONQUIN ROAD, IL01/3RD, SCHAUMBURG, IL, 60196, US

(21) Appl. No.: 11/304,190

(22) Filed: Dec. 15, 2005

(51) Int. Cl. G06F 17/30

(52) U.S. Cl. 707/204

(57) ABSTRACT

A method of storing data in a network database system comprising receiving a first value for a dataset, the first value corresponding to a first node, storing the first value for the dataset, receiving a second value for the dataset, the second value corresponding to a second node, wherein the first value is different from the second value, identifying a conflict between the first value for the dataset and the second value for the dataset, and storing the second value for the dataset along with the first value for the dataset and resolving the conflict by query of an authoritative data source.

### BACKGROUND OF THE INVENTION

1. Field of the Invention

The present invention relates to database systems. More specifically, the present invention relates to conflict resolution in highly available database systems.

2. Discussion of the Related Art

In replicated data storage systems where updates can occur at any node within the system, data conflicts are a well known problem. Replicated data storage systems are database systems that have a copy of the database located at multiple locations (i.e., nodes) within the system. Each node within the system has a copy of the database stored locally. Each node can independently update the data within their local copy of the database. Generally, this update is then propagated to the other nodes within the system. Data conflicts occur when two or more nodes disagree as to the correct data within the database system. The goal of conflict resolution is to ensure that all data on all nodes is the same. Since any data can be updated on any node, and because there is a time lag to propagate data from one node to the other nodes, conflicts can not be prevented (i.e., it is always possible to have crossing updates between two or more nodes). The first thing for any database system with replication is to be able to identify a conflict. Once the conflict has been recognized, there are various method for resolving conflicts that have been utilized in an attempt to minimize the number of occurrences of incorrect data being stored anywhere within the database system.

One approach is to use timestamp conflict resolution. When using timestamp conflict resolution each database entry includes a timestamp associated with the database entry. If there is a conflict between two entries, the entry with the latest timestamp will always be used. However, if the difference in time between clocks on an active-active highly available machines is greater than the minimum time between sequential updates to the same object on different machines, then the timestamp conflict resolution method will be incorrect.

Further, in the case where some identifying data is included when data is replicated between machines, (such as the base timestamp of the object before it was updated, or the base data values of the object before it was updated) absent application specific rules, in the case of crossing updates, it is not possible to determine whether a replicated update should be applied to the database. In this case it is only possible to log the conflict and make some fall-back decision which may have a negative effect on the availability of the system, specifically the availability associated with the user of the system with whom the data is associated.

### BRIEF DESCRIPTION OF THE DRAWINGS

The above and other aspects, features and advantages of the present invention will be more apparent from the following more particular description thereof, presented in conjunction with the following drawings, wherein:

FIG. 1 illustrates an example of an update to the database system in accordance with one embodiment;

FIG. 2 illustrates an example of an update to the database system in accordance with another embodiment;

FIG. 3 illustrates an example of a conflict within the database system in accordance with one embodiment;

FIG. 4 is a flow diagram illustrating immediate conflict resolution in accordance with one embodiment;

FIG. 5 is a flow diagram illustrating a successful immediate conflict resolution in accordance with one embodiment;

FIG. 6 is a flow diagram is shown illustrating a failed immediate conflict resolution in accordance with one embodiment;

FIG. 7 is a flow diagram illustrating delayed conflict resolution in accordance with one embodiment;

FIG. 8 is a flow diagram illustrating a successful delayed conflict resolution in accordance with one embodiment; and

FIG. 9 is a flow diagram illustrating a failed delayed conflict resolution in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

The present embodiments provide a solution to addressing conflicts in database systems that eliminates the need to keep accurate time on each of the machines within the database system and ensures that data remains available in cases where propagation of updates cross within the database system. In some embodiments, an authoritative source is utilized to perform conflict resolution either immediately upon identifying the conflict or as the load on the database system permits.

One embodiment can be characterized as a method of storing data in a network database system comprising receiving a first value for a dataset, the first value corresponding to a first node; storing the first value for the dataset; receiving a second value for the dataset, the second value corresponding to a second node, wherein the first value is different from the second value; identifying a conflict between the first value for the dataset and the second value for the dataset; and storing the second value for the dataset along with the first value for the dataset.

Another embodiment can be characterized as a method of resolving a conflict in a network database system comprising storing a first value for a dataset, the first value corresponding to a first node; storing a second value for the dataset, the second value corresponding to a second node, wherein the first value is different from the second value; initiating a first process based upon the first value for the dataset; initiating a second process based upon the second value for the dataset; and deleting one of the first value for the dataset and the second value for the dataset based upon the outcome of at least one of the first process and the second process.

Yet another embodiment includes a method of resolving a conflict in a network database system comprising storing a first value for a dataset, the first value corresponding to a first node; storing a second value for the dataset, the second value corresponding to a second node, wherein the first value is different from the second value; receiving a request for the dataset from a requesting thread; creating a clone of the requesting thread; providing the first value for the dataset to the requesting thread, the requesting thread running a first process; providing the second value for the dataset to the clone of the requesting thread, the clone of the requesting thread running a second process; and deleting one of the first value for the dataset and the second value for the dataset based upon the outcome of at least one of the first process and the second process.

The following embodiments described herein will be described with the assumption that data stored in the database system contains volatile and non-authoritative data. That is, the data in the database can eventually be reloaded from some other authoritative data location, and the data is subject to change at any time. Therefore, the embodiments described herein are applicable to, for example, Visited Location Registers (VLRs) which store temporary data, such as for example, provisioning information about subscribers serviced by the a mobile station and mobility management information about the subscribers. For example, a VLR may think that a subscriber is in Chicago when the subscriber is actually in New York. The subscriber is the authoritative source that can correct the data in the VLR because the subscriber will always know its current location. Many other types of database systems, such as a web search engines, also can utilize the embodiments described herein. While the above assumptions apply to the embodiments described herein, the embodiments described herein should not be limited only to database systems including all of the above assumptions.

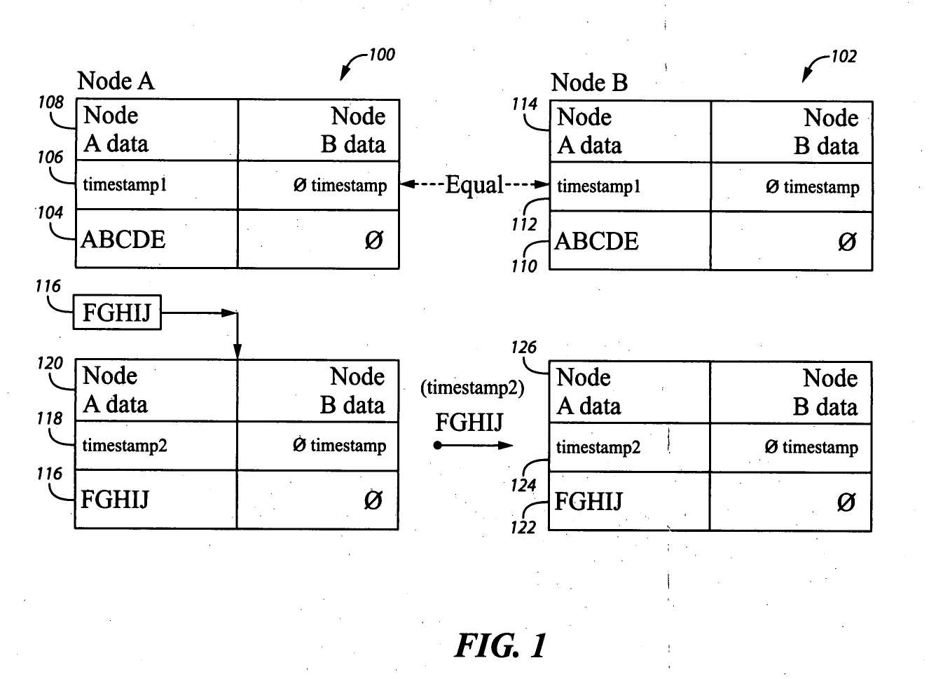

Referring to FIG. 1, an example of an update to the database system is shown in accordance with one embodiment. Shown is a first node 100 and a second node 102.

The first node 100 (shown as Node A) is, for example, a computer that includes a database. The second node 102 (shown as Node B) is also, for example, a computer that includes a copy of the database. At the outset, the first node 100 and the second node 102 have equal values for all the data in their database.

In the example shown the data 104 stored in the first node 100 has an initial value of “ABCDE.” Additionally, stored along with the data 104 is a value of the first timestamp 106. The data 104 and the timestamp 106 are also associated with a designation 108 that indicates in the system that the data 104 originated from the first node 100. The data 110 stored in the second node 102 additionally has the same value “ABCDE” as the data 104 stored in the first node 100. Additionally, the timestamp 112 associated with the data 110 is stored in the second node 102. The data 110 and the timestamp 112 are stored at the second node 102, however, are associated with a designation 114 corresponding to the first node 100. Thus, the second node 102 knows that the data 110 originated from the first node 100.

In operation, the first node 100 receives an update of data 116. In the example shown the update of the data 116 has a value of “FGHIJ.” The first node 100 stores the new value for the data and additionally stores a new timestamp 118. Because the data came into the first node from an authoritative source and not from the second node, the data 116 also has a designation 120 associated with the first node 100. Following, the data 116, along with the timestamp 118 and designation 120 are propagated to the second node 102. The second node 102 overwrites the original data 110, timestamp 112 and designation 114, with new data 122, a new timestamp 124 and a new designation 126. No conflict exists as the data 104 was originally associated with the first node 100 and the update of the data 116 is also associated with the first node 100. Throughout the example shown, there is never any data associated with the second node 102 or stored within the database in the section associated with the second node 102.

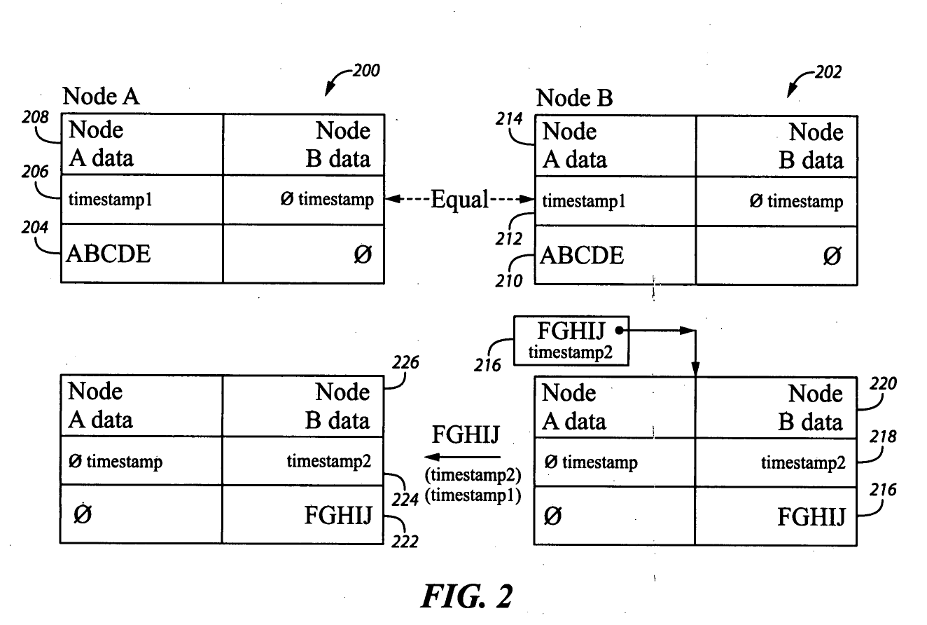

Referring to FIG. 2, a second example of an update to the database system is shown in accordance with another embodiment. Shown is a first node 200 and a second node 202. As with the example shown in FIG. 1, both databases start out with the same starting condition (i.e., all of the data in both nodes is the same).

In the example shown the data 204 stored in the first node 200 has an initial value of “ABCDE.” Additionally, stored along with the data 204 is a value of the first timestamp 206. The data 204 and the timestamp 206 are associated with a designation 208 that indicates in the system that the data 204 came from the first node 200. The data 210 stored in the second node 202 additionally has the same value “ABCDE” as the data 204 stored in the first node 200. Additionally, the timestamp 212 associated with the data 210 is stored in the second node 202. The data 210 and the timestamp 212 are stored at the second node 202, however, are associated with a designation 214 corresponding to the first node 200. Thus, the second node 202 knows that the data 210 came from the first node 200.

In operation, the second node 202 receives an update of data 216 having a value of “FGHIJ.” The update of data 216 is stored along with a second timestamp 218. The update of data 216 and the timestamp 218 are associated with a designation 220 that corresponds to the second node 202. Additionally, the update of data 216 comes from an authoritative source. Because the data comes from the authoritative source the second node 202 knows that the update of data 216 is correct. Thus, the data 210 and the timestamp 212 that are associated with the first node 200 and stored in the second node 202 can be deleted. As shown, the original data having a value of “ABCDE” has been deleted from the second node 202.

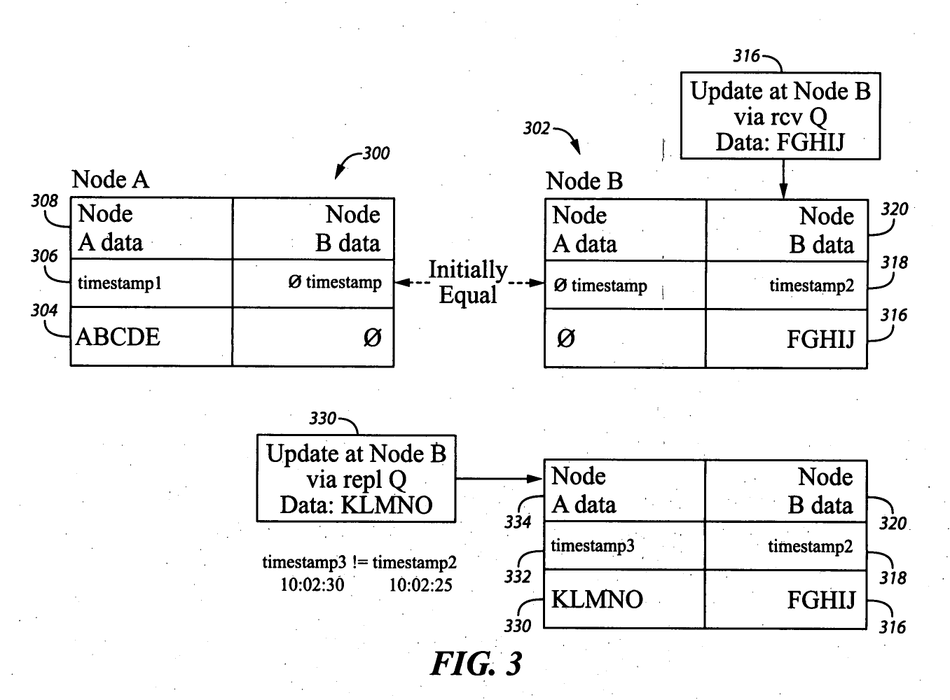

Following, the update of data 216 is propagated to the first node 200. The update of data 216 having a value of FGHIJ is sent to the first node with the second timestamp 218. Additionally, the second node 202 sends the first timestamp 212 to the second node. In this manner, the first node 200 is able to determine that the second node received an update of the original data 204 and the original timestamp 206. Thus, the first node is able to determine that there is no conflict between the first node 200 and the second node 202. The first node stores the new data 222 and the new timestamp 224 along with the designation 226 for the second node. In this manner, the first node 200 keeps track of where the update of data 216 originated from. The original data 204 and the original timestamp 206 are deleted from the first node 200 after the first node 200 validates that update of data 216 was an update to the same base value for the data that was stored in both nodes (i.e., ABCDE and timestamp 1). As described, when data is propagated from one database to another within the system, along with the data is sent an indication of what the previous data (e.g., base value) was prior to the update. In the example given above, the original timestamp 206 was transmitted with the updated of data 216 and the second timestamp 218 to give an indication of what the previous data was prior to the update. This information is used to determine when a conflict exists and will be described below with reference to FIG. 3. As shown in FIGS. 1 and 2, data can be updated from either the first node 200 or the second node 202.

For the examples described above in FIGS. 1 and 2, the normal operation of the highly available database system is shown where there is not a conflict between the data within the databases.

Referring to FIG. 3, an example of a conflict within the database system is shown in accordance with one embodiment. Shown is a first node 300 and a second node 302.

Similarly to the examples shown in FIGS. 1 and 2, the data 304 stored in the first node 300 has an initial value of “ABCDE.” Additionally, stored along with the data 304 is a value of the first timestamp 306. The data 304 and the timestamp 306 are associated with a designation 308 that indicates in the system that the data 304 came from the first node 300. Initially, the data in the both the first node 300 and the second node 302 are equal.

In operation, the second node 302 receives an update of data 316 having a value of “FGHIJ” from a receive queue. The update of data 316 is stored along with a second timestamp 318. The update of data 316 and the timestamp 318 are stored in the database and are associated with designation 320 indicating the data corresponds to the second node 302. Additionally, the update of data 316 comes from an authoritative source. As shown, the data and timestamp originally associated with the first node 300 is then deleted from the second node 302.

Additionally, the second node 302 receives an update of data 330 from the first node 300 via the replication queue (i.e., the propagation of data between databases). The update of data 330 has a value of “KLMNO.” The update of data 330 from the first node 300 includes a third timestamp 332. Additionally sent with the update of data 330 from the first node 300 is an indication about the value of the original data prior to the update (e.g., the original timestamp 306). For example, the original timestamp 306 is sent along with the update of data 330 in order to indicate to the second node 302 that the update of data 330 is an update of the original data 304. Because both the update of data 316 from the receive queue and the update of data 330 from the replication queue are both updates of the data 304 that is associated with the original timestamp 306, we now have a conflict within the database system. In accordance with the present embodiment, both the update of data 316 from the receive queue and the update of data 330 from the replication queue are stored at the second node 302. Both pieces of data will be stored until the conflict is resolved. While not shown, the same data will also be stored in at the first node 300. This is in contrast to prior systems where the data with the later timestamp would be stored and the other piece of data discarded. This is one example of how a conflict can occur and be identified within a highly available database system. Other conflicts may occur and different methods may be used to identify a conflict within the system.

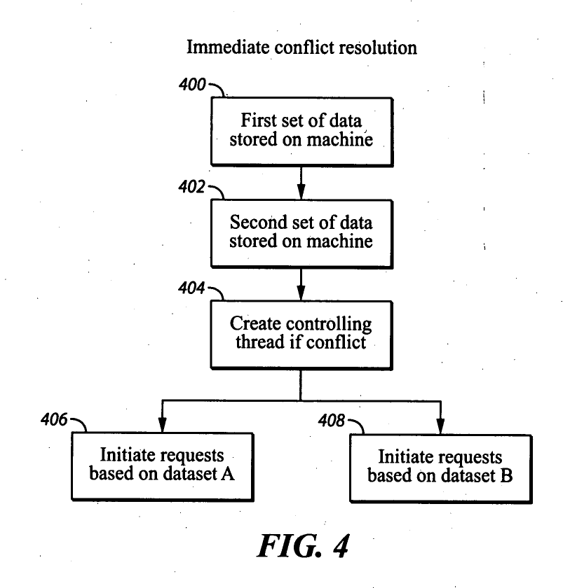

The examples described below in FIGS. 4-9 provide methods for resolving conflicts once they have been identified within the system.

Referring to FIG. 4 a flow diagram is shown illustrating immediate conflict resolution in accordance with one embodiment.

In step 400 a first set of data is stored in a database. The database can be located on a computer or in a highly available memory device connected to the computer. Following, in step 402 a second set of data is stored in the database. In the present example, we assume that the first set of data and the second set of data are in conflict.

Next in step 404, a controlling thread is created once the conflict is identified. In step 406 a first request is made based upon the first set of data stored in the database and in step 408 a second request is made based upon the second set of data stored in the database. Preferably, step 406 and step 408 are initiated and run simultaneously. In the example of a subscriber VLR, assume the first set of data indicates the subscriber is in Chicago and the second set of data indicates the subscriber is in Milwaukee. The first request will send a location request to Chicago. The second request will send a location request to Milwaukee. Because the subscriber can only physically be in one place at a time, only one of the requests will return a positive answer. Thus, the conflict has been resolved the incorrect set of data can be discarded from the database.

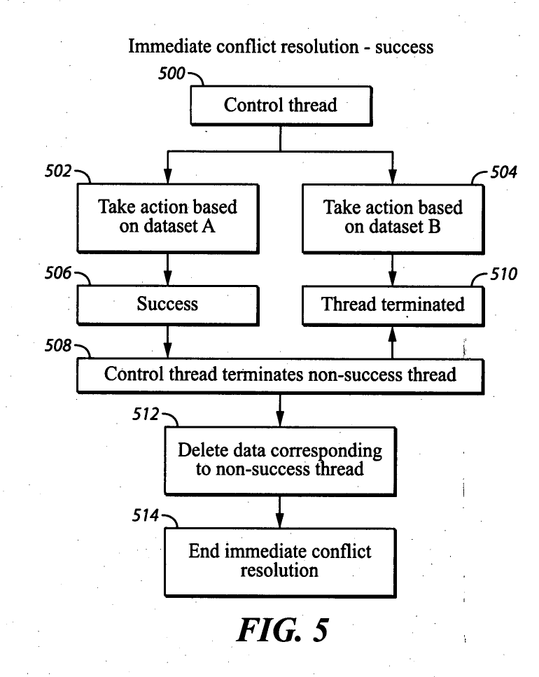

Referring next to FIG. 5, a flow diagram is shown illustrating a successful immediate conflict resolution in accordance with one embodiment.

In step 500 a control thread is created similarly to the control thread shown in FIG. 4. In step 502 an action or request is taken based upon a first set of data stored in the database. In step 504 an action or request is taken based upon a second set of data stored in the database. As stated above, preferably step 502 and step 504 are run simultaneously, however, this is not required. In the example shown, step 506 shows that step 502 has succeeded in resolving the conflict. The success is sent to the control thread in step 508 and the control thread initiates termination of the action based upon the second set of data. In step 510, the action based upon the second set of data is terminated by the control thread.

In step 512, the second set of data is deleted from the database and in step 514 the control thread is terminated.

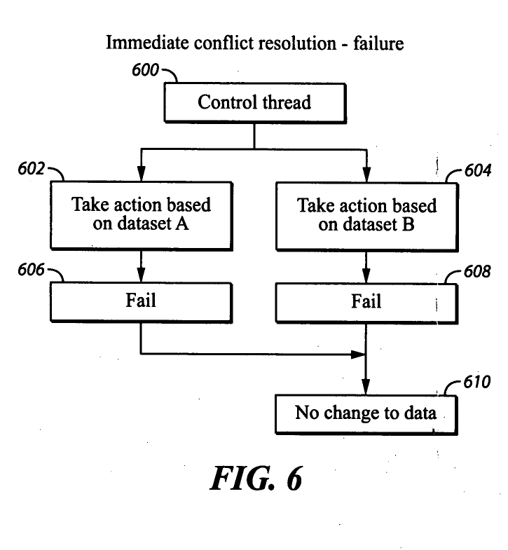

Referring to FIG. 6 a flow diagram is shown illustrating a failed immediate conflict resolution in accordance with one embodiment.

In step 600 a control thread is created similarly to the control thread shown in FIG. 5. In step 602 an action or request is taken based upon a first set of data stored in the database. In step 604 an action or request is taken based upon a second set of data stored in the database. As stated above, preferably step 602 and step 604 are run simultaneously, however, this is not required. In step 606 the first action returns a failure and in step 608 the second action returns a failure. In this situation, in step 610, both the first set of data and the second set of data continue to be stored in the database until the conflict is resolved.

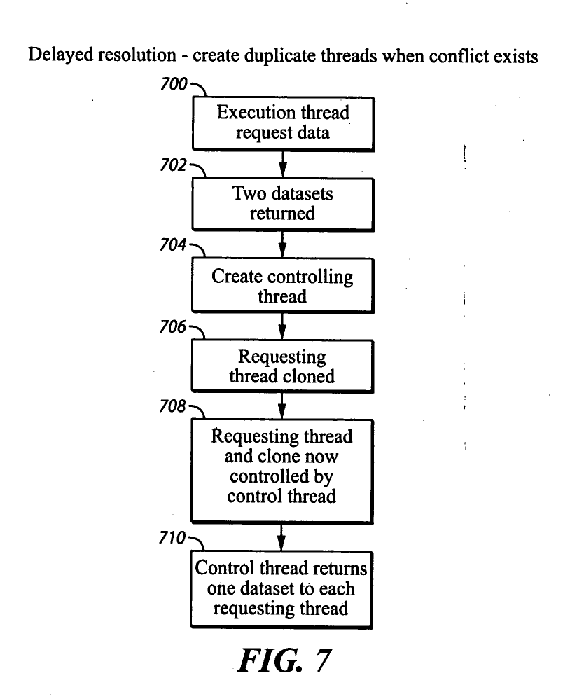

Referring to FIG. 7 a flow diagram illustrating delayed conflict resolution is shown in accordance with one embodiment.

In step 700, an execution thread requests data from the database. For the present example, assume that the requested data includes two sets of conflicting data. In step 702 two sets of data are returned (i.e., a first set of data and a second set of data). Following in step 704 a control thread is created. In step 706, the execution thread that requested the data from the database is cloned. Following in step 708 the original execution thread and the cloned thread are now controlled by the control thread. In step 710, control thread returns the first set of data to the execution thread and the second set of data is returned to the cloned thread.

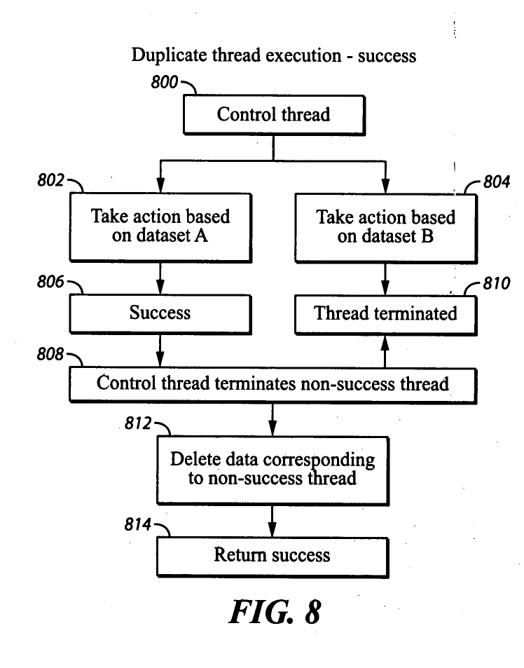

Referring to FIG. 8 a flow diagram is shown illustrating a successful delayed conflict resolution in accordance with one embodiment.

In step 800 a control thread is created. In step 802 an action or request is taken by the execution thread based upon a first set of data stored in the database. In step 804 an action or request is taken by the cloned thread based upon a second set of data stored in the database. Preferably step 802 and step 804 are run simultaneously, however, this is not required. In the example shown, step 806 shows that step 802 has succeeded in resolving the conflict. The success in sent to the control thread in step 808 and the control thread initiates termination of the action based upon the second set of data. It should be understood that the success and failure in independent of whether the thread is the original execution thread or the cloned thread. In step 810, the action based upon the second set of data is terminated by the control thread (i.e., the cloned thread is terminated in the present example).

In step 812, the second set of data is deleted from the database and in step 814 the control thread returns a success.

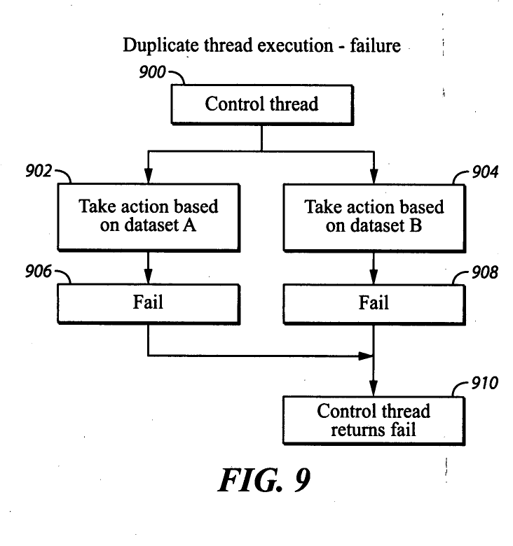

Referring to FIG. 9, a flow diagram is shown illustrating a failed delayed conflict resolution in accordance with one embodiment.

In step 900 a control thread is created. In step 902 an action or request is taken by the execution thread based upon a first set of data stored in the database. In step 904 an action or request is taken by the cloned thread based upon a second set of data stored in the database. In step 906 the first action returns a failure and in step 908 the second action returns a failure. In this situation, in step 610, both the first set of data and the second set of data continue to be stored in the database and the control thread returns a failure.

In addition the above examples of conflict resolution, when a node (e.g., Node B) within the highly available network database system has been off-line and is coming on-line, Node A will transfer a complete set of data in its datastore to Node B. When storing data from Node A in this manner, the associations for all the data will be preserved. For example, if Node A has a single copy of data at a location that is associated with Node A, when the data is transferred to Node B, Node B will store the data at the same location and associate the data with Node A. Similarly, if Node A has two copies of data stored at a location, once copy associated with Node A and another copy associated with Node B, when the data is transferred to Node B, the data associated with Node A will remain associated with Node A, and the data associated with Node B will remain associated with Node B.

In the above procedure, Node B may already have some of amount of data in its datastore. That is, while off-line, the data on Node B may not have been erased. In the case that Node B receives data from Node A for a location which it already has data, the following actions will take place. When the data from Node A is associated with Node A, if Node B already has data stored which is associated with Node A, Node B will overwrite the data. When the data from Node A is associated with Node B, if Node B already has data which is associated with Node B, it will discard the data from Node A. Please note that the above procedure relating to when a node comes on-line also applies to the situation when communication between nodes in the system has been interrupted.

The embodiments described herein allow highly available database systems to avoid post processing of conflicts by a user in favor of a more reliable, automated method which assures that replicated data will not be dropped and that replicated data will always result in correct procedures based on the applications running with the stored data as inputs. In this manner, the embodiments implement datastores that are self correcting and highly available.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A method of storing data in a network database system comprising:
receiving a first value for a dataset, the first value corresponding to a first node;
storing the first value for the dataset;
receiving a second value for the dataset, the second value corresponding to a second node, wherein the first value is different from the second value;
identifying a conflict between the first value for the dataset and the second value for the dataset; and
storing the second value for the dataset along with the first value for the dataset.

2. The method of storing data in a network database system of claim 1 further comprising:
initiating a first process based upon the first value for the dataset; and
initiating a second process based upon the second value for the dataset.

3. The method of storing data in a network database system of claim 2 further comprising deleting one of the first value for the dataset and the second value for the dataset based upon the outcome of at least one of the first process and the second process.

4. The method of storing data in a network database system of claim 3 further comprising creating a control thread to control the steps of initiating the first process and initiating the second process.

5. The method of storing data in a network database system of claim 3 wherein the first value for the dataset and the second value for the dataset can be validated from an authoritative source.

6. The method of storing data in a network database system of claim 1 wherein the network database system is a visitor location register.

7. A method of resolving a conflict in a network database system comprising:
storing a first value for a dataset, the first value corresponding to a first node;
storing a second value for the dataset, the second value corresponding to a second node, wherein the first value is different from the second value;
initiating a first process based upon the first value for the dataset;
initiating a second process based upon the second value for the dataset; and
deleting one of the first value for the dataset and the second value for the dataset based upon the outcome of at least one of the first process and the second process.

8. The method of resolving a conflict in a network database system of claim 7 further comprising creating a control thread to control the steps of initiating the first process and initiating the second process.

9. The method of storing data in a network database system of claim 7 wherein the first value for the dataset and the second value for the dataset can be validated from an authoritative source.

10. The method of storing data in a network database system of claim 7 wherein the network database system is a visitor location register.

11. The method of storing data in a network database system of claim 7 further comprising receiving a request for the dataset from a requesting thread.

12. The method of storing data in a network database system of claim 11 further comprising:
creating a clone of the requesting thread;
providing the first value for the dataset to the requesting thread, the requesting thread initiating the first process; and
providing the second value for the dataset to the clone of the requesting thread, the clone of the requesting thread initiating the second process.

13. A method of resolving a conflict in a network database system comprising:
storing a first value for a dataset, the first value corresponding to a first node;
storing a second value for the dataset, the second value corresponding to a second node, wherein the first value is different from the second value;
receiving a request for the dataset from a requesting thread;
creating a clone of the requesting thread;
providing the first value for the dataset to the requesting thread, the requesting thread running a first process;
providing the second value for the dataset to the clone of the requesting thread, the clone of the requesting thread running a second process; and
deleting one of the first value for the dataset and the second value for the dataset based upon the outcome of at least one of the first process and the second process.

14. The method of storing data in a network database system of claim 13 wherein the first value for the dataset and the second value for the dataset can be validated from an authoritative source.

15. The method of storing data in a network database system of claim 13 wherein the network database system is a visitor location register.
